(19) United States
(12) Patent Application Publication
(10) Pub. No.: US 2020/0171592 A1
(43) Pub. Date: Jun. 4, 2020

(54) METHOD FOR MANUFACTURING CONE BY ELECTROCHEMICAL MACHINING

(71) Applicant: METAL INDUSTRIES RESEARCH & DEVELOPMENT CENTRE, KAOHSIUNG CITY (TW)

(72) Inventors: ZHI-WEN FAN, KAOHSIUNG CITY (TW); DA-YU LIN, KAOHSIUNG CITY (TW); CHEN-HUI CHANG, KAOHSIUNG CITY (TW); CHUN-WEI CHEN, KAOHSIUNG CITY (TW); CHIU-FENG LIN, KAOHSIUNG CITY (TW)

(21) Appl. No.: 16/208,748

(22) Filed: Dec. 4, 2018

(51) Int. Cl. B23H 3/04; B23H 7/26; B23H 9/18

(52) U.S. Cl. CPC B23H 3/04; B23H 7/26; B23H 2400/10; B23H 2200/00; B23H 9/18

(57) ABSTRACT

The present invention relates to an electrochemical machining method for manufacturing a cone. One or more conductive column and an electrode are driven to perform relative convolute motion. Then the conductive column is driven to perform electrochemical machining on the electrode for forming one or more hole in the electrode. Afterwards, the periphery of the hole in the electrode to perform electrochemical machining on the conductive column for forming a cone at one end of the conductive column.

### FIELD OF THE INVENTION

The present invention relates generally to a method for electrochemical machining, and particularly to a method for manufacturing a cone by electrochemical machining.

### BACKGROUND OF THE INVENTION

A general cone, such as a probe, is formed by machining high-hardness materials. In the early times, high-hardness materials are machined by traditional mechanical machining to form a cone. In other words, mechanical force is adopted to cut high-hardness materials. Nonetheless, mechanical force is disadvantageous for a workpiece to form a cone; the surface of the formed cone is also rougher. In addition, by using mechanical force, it is difficult to form the fragile tip of a cone. Breakage occurs easily at the tip.

To solve the shortcoming of traditional mechanical machining, nowadays, the electromechanical machining is adopted to machine high-hardness materials for forming a cone. Although the above problem can be solved by applying electromechanical machining, machining products will be produced during the process of performing electromechanical machining on a workpiece. The machining products will accumulate at the end portion of the workpiece and hence hindering the workpiece from forming a cone by electromechanical machining.

### SUMMARY

An objective of the present invention is to provide a method for manufacturing a cone by electrochemical machining. In the machining process, a conductive column and an electrode are driven to perform relative convolute motion for disturbing the electrolyte and thus carrying away the machining products. It is beneficial for machining the conductive column to form a cone by avoiding accumulation of machining products at the end of the conductive column.

The present invention discloses a method for manufacturing a cone by electrochemical machining, comprising steps of: driving one or more conductive column and an electrode to perform relative convolute motion; driving the conductive column and the electrode to perform relative approaching motion; driving the conductive column to perform electrochemical machining on the electrode for forming one or more hole in the electrode; driving the conductive column and the electrode to perform relative parting motion; and driving the periphery of the hole in the electrode to perform electrochemical machining on the conductive column for forming a cone at one end of the conductive column in the process when the conductive column and the electrode perform relative parting motion.

### BRIEF DESCRIPTION OF THE DRAWINGS

FIG. 1 shows a flowchart of the electromechanical machining method for manufacturing a cone according to an embodiment of the present invention;

FIG. 2A to FIG. 2F show schematic diagrams of the electromechanical machining method for manufacturing a cone according to an embodiment of the present invention;

FIG. 3A shows a front view of the electromechanical machining apparatus according to an embodiment of the present invention;

FIG. 3B shows a stereoscopic view of the electromechanical machining apparatus according to an embodiment of the present invention;

FIG. 4A shows a front view of the convolute motion mechanism of the electromechanical machining apparatus according to an embodiment of the present invention;

FIG. 4B shows a stereoscopic view of the convolute motion mechanism of the electromechanical machining apparatus according to an embodiment of the present invention;

FIG. 5A shows an exploded view of the crankshaft of the electromechanical machining apparatus according to an embodiment of the present invention;

FIG. 5B shows a stereoscopic view of the crankshaft of the electromechanical machining apparatus according to an embodiment of the present invention;

FIG. 5C shows a schematic diagram of adjusting the eccentric distance of the crankshaft of the electromechanical machining apparatus according to an embodiment of the present invention;

FIG. 6A shows a stereoscopic view of the convolution carrier of the electromechanical machining apparatus according an embodiment of the present invention;

FIG. 6B shows an enlarged view of the partial zone A in FIG. 6A;

FIG. 7A shows an exploded view of the convolution carrier of the electromechanical machining apparatus according an embodiment of the present invention; and

FIG. 7B shows an enlarged view of the partial zone B in FIG. 7A.

### DETAILED DESCRIPTION

In order to make the structure and characteristics as well as the effectiveness of the present invention to be further understood and recognized, the detailed description of the present invention is provided as follows along with embodiments and accompanying figures.

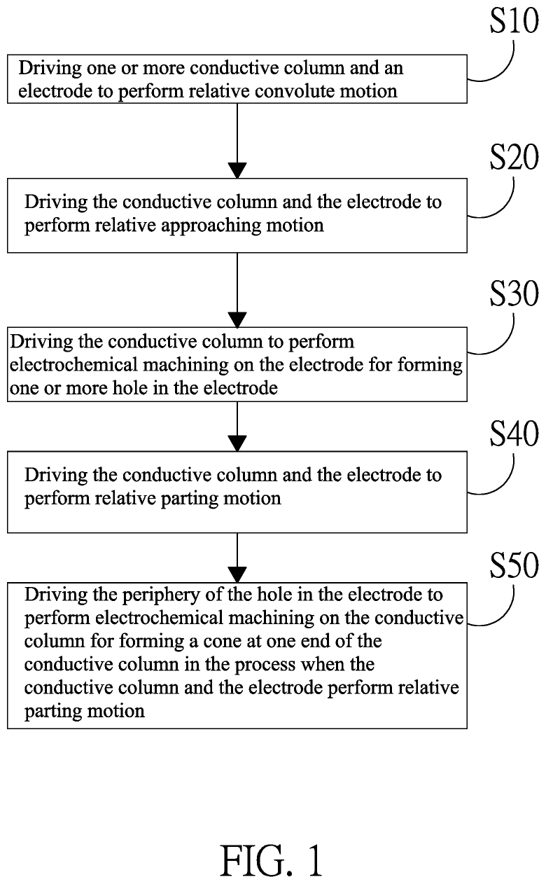

Please refer to FIG. 1, which shows a flowchart of the electromechanical machining method for manufacturing a cone according to an embodiment of the present invention. The electromechanical machining method for manufacturing a cone comprises steps of:
Step S10: Driving one or more conductive column and an electrode to perform relative convolute motion;
Step S20: Driving the conductive column and the electrode to perform relative approaching motion;
Step S30: Driving the conductive column to perform electrochemical machining on the electrode for forming one or more hole in the electrode;
Step S40: Driving the conductive column and the electrode to perform relative parting motion; and
Step S50: Driving the periphery of the hole in the electrode to perform electrochemical machining on the conductive column for forming a cone at one end of the conductive column in the process when the conductive column and the electrode perform relative parting motion.

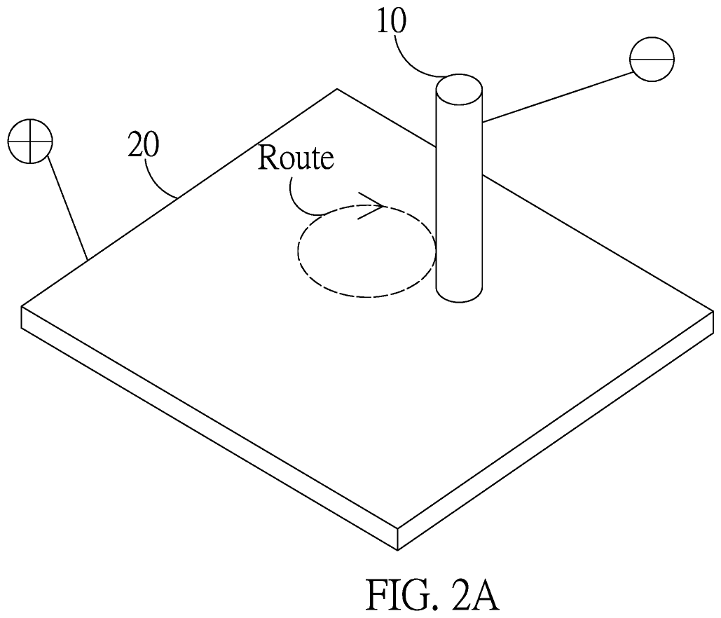

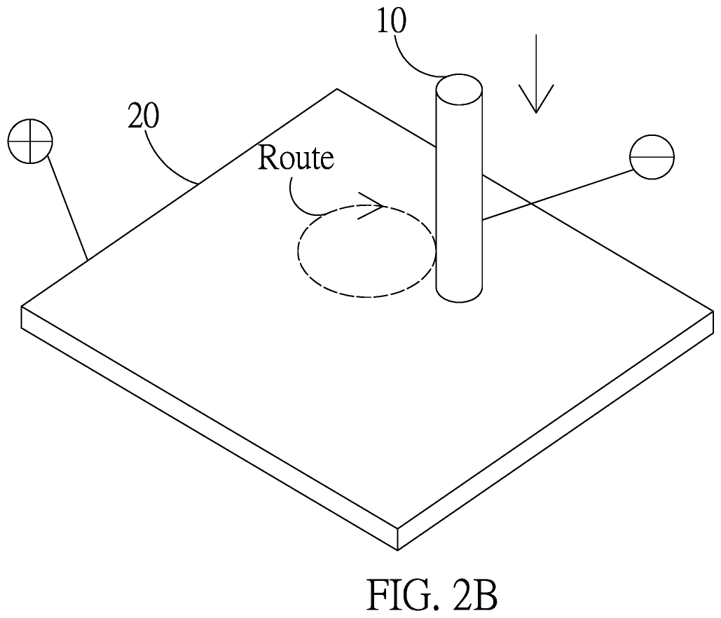

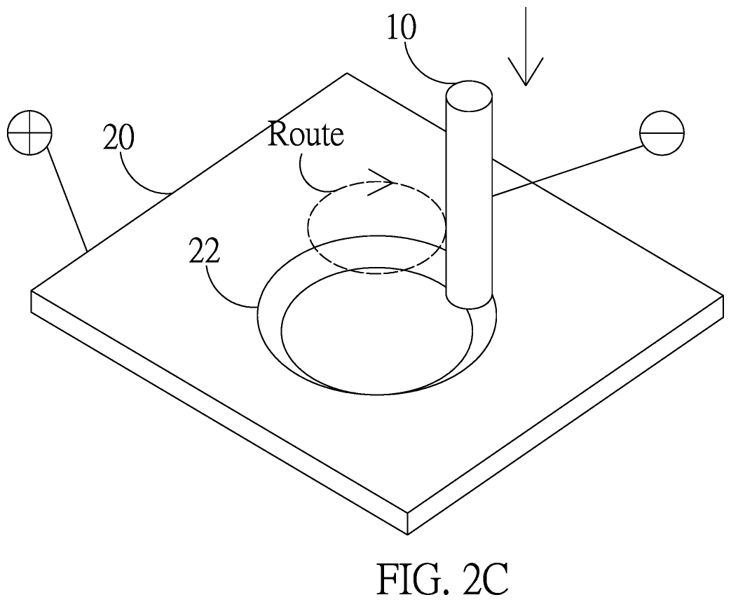

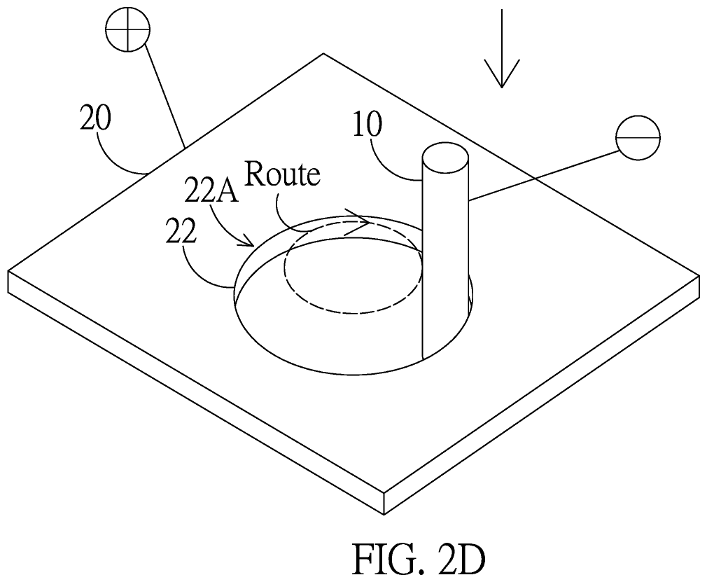

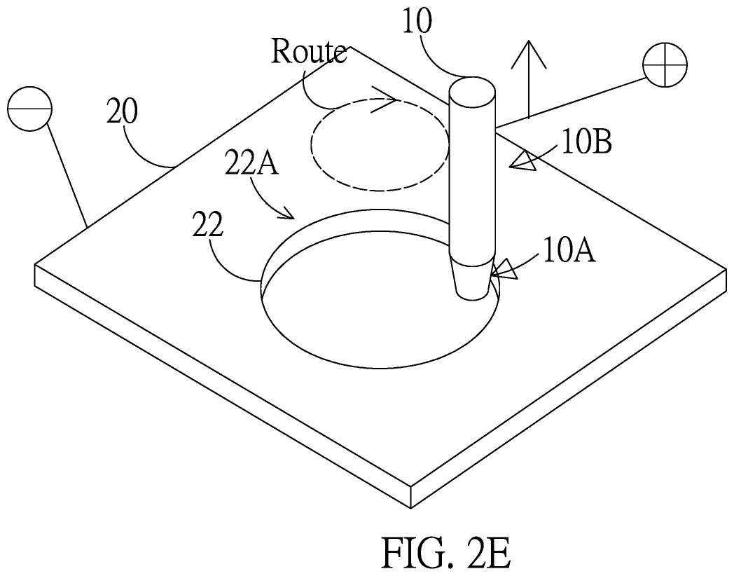

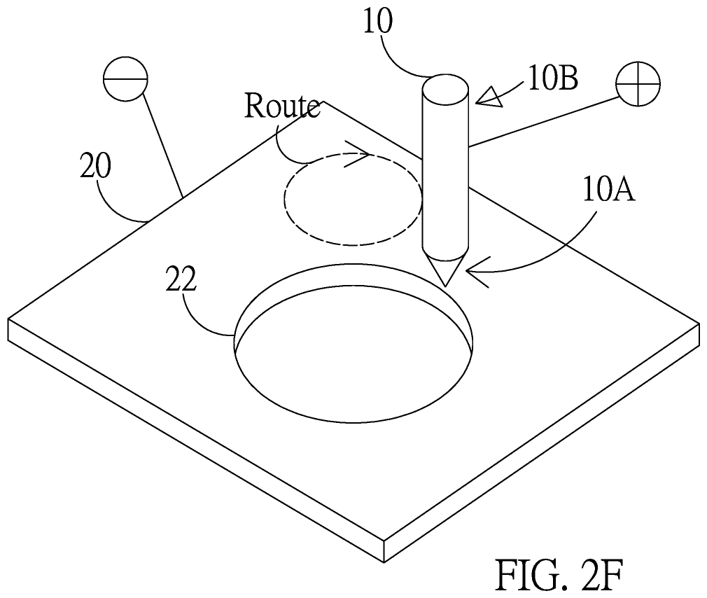

As shown in FIG. 2A, the conductive column 10 and the electrode 20 perform relative convolute motion. The electrode 20 can be a plate. According to an embodiment of the present invention, the conductive column 10 is driven to perform continuous convolute motion along a convolution route. The conductive column 10 might have no spin motion; and the convolution route can be a circle.

As shown in FIG. 2B, the conductive column 10 is driven to perform linear motion and approach the electrode 20. The conductive column 10 continues to perform convolute motion along the convolution route. In addition, the conductive column 10 is coupled to a cathode of a power supply (not shown in the figure) and the electrode is coupled to an anode of the power supply for driving the conductive column 10 to perform electrochemical machining on the electrode 20, as shown in FIG. 2C, for forming one or more hole 22 in the electrode 20.

As shown in FIG. 2D, when the conductive column 10 performs electrochemical machining on the electrode 20 and forming the hole 22 in the electrode 20, the conductive column 10 can further continue the linear motion and extend through the hole 22. As shown in FIG. 2E, the conductive column 10 and the electrode 20 are driven to perform relative parting motion. According to the present embodiment, in addition to continuing performing convolute motion, the conductive column 10 also perform linear motion in the direction away from the electrode 20 and thus parting the hole 22 gradually.

Furthermore, as shown in FIG. 2E and FIG. 2F, exchange the polarity of the conductive column 10 and the electrode 20. Namely, the conductive column 10 is coupled to the anode of the power supply while the electrode 20 is coupled to the cathode. By using the periphery 22A of the hole 22 of the electrode 20 to perform electrochemical machining on the end 10A of the conductive column 10, the end 10A of the conductive column 10 facing the periphery 22A of the hole 22 is acted by electrochemical reactions for forming a cone gradually in the process when the conductive column 10 parts the hole 22. According to the above description, the machining method according to the present invention drives the conductive column 10 and the electrode 10 to perform relative convolute motion and the conductive column 10 can have no spin motion. Then the conductive column 10 and the periphery 22A of the hole 22 can perform relative convolute motion and the periphery 22A of the hole 22 is used to perform electrochemical machining on the end 10A of the conductive column 10. Thereby, the end 10A of the conductive column 10 forms a cone.

The conductive column 10 first performs electrochemical machining on the electrode 20 to form the hole 22 in the electrode 20. Then the periphery 22 of the hole 22 performs electrochemical machining on the end 10A of the conductive column 10 to form a cone. Thereby, in the machining process, it is not required to realign the conductive column 10 and the electrode 20. The unmachined end 10B (the stem part) and the machined end 10A (the cone part) of the finished conductive column 10 own the highly coaxial property. In addition, because the conductive column 10 performs convolute motion along the periphery of the hole 22, namely, along a fixed route, the electrochemical machining region can be confined. Then the electrochemical machining can be confined to the periphery 22A of the hole 22. Because the periphery 22A owns high electric-field intensity for electrochemical machining, the machining quality for the conductive column 10 can be improved. Besides, because the conductive column 10 and the electrode 10 continues to perform convolute motion, the electrolyte can be perturbed continuously and hence carrying away the machining products. Consequently, it is beneficial for machining the end 10A of the conductive column 10 to form a cone by avoiding accumulation of machining products at the end 10A of the conductive column 10.

Moreover, in the process when the conductive column 10 and the electrode 20 performs relative parting motion, the motion speed of the relative parting motion can be further adjusted for reducing the motion speed as the electrochemical machining time increases. In other words, as the time of electrochemical machining performed by the periphery 22A of the hole 22 on the conductive column 10 increases, the motion speed of the relative parting motion between the conductive column 10 and the electrode 20 is reduced. That is to say, the motion speed slows down gradually as the electrochemical machining proceeds.

According to the present embodiment, the conductive column 10 is driven to perform convolute motion along the convolution route continuously while the electrode 20 is maintained still. Alternatively, the conductive column 10 can be maintained fixed and the electrode 20 can be driven to perform convolute motion. Then the conductive column 10 and electrode 20 are driven to perform relative convolute motion as well. Likewise, the electrode 20 can be driven to perform linear motion while the conductive column 10 is maintained still for performing relative approaching motion or relative parting motion.

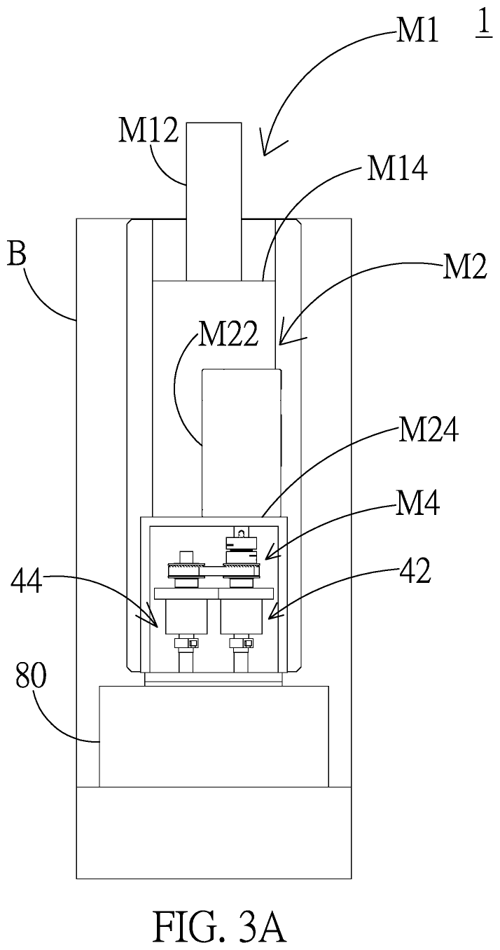

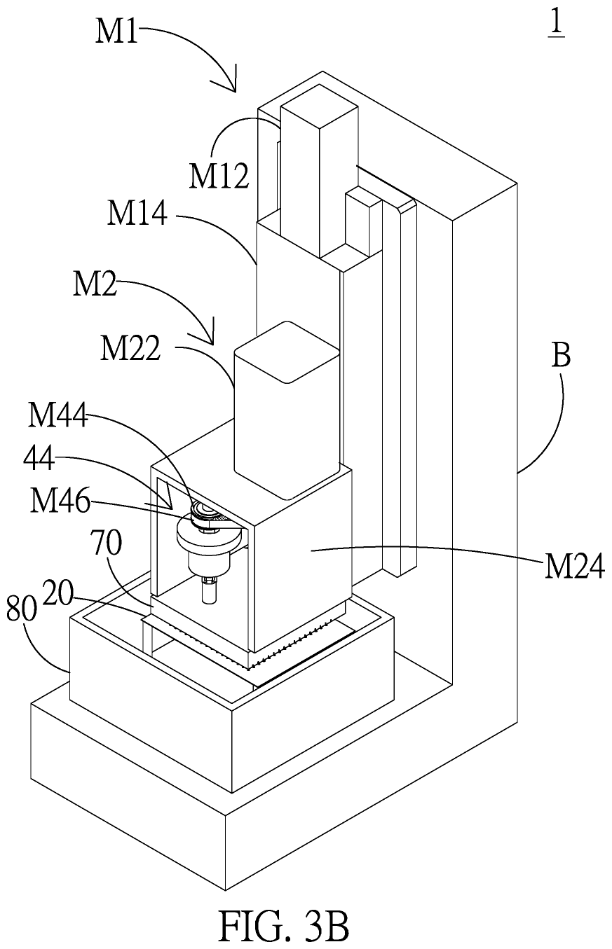

Please refer to FIG. 3A and FIG. 3B, which show a front view and a stereoscopic view of the electromechanical machining apparatus according to an embodiment of the present invention. As shown in the figures, the electrochemical machining apparatus 1 comprises a base B, a linear motion mechanism M1, and a convolute motion mechanism M2. The linear motion mechanism M1 includes a linear driver M12 and a mobile base M14. The linear driver M12 and the mobile base M14 are disposed on the base B. The mobile base M14 is connected with the linear driver M12. The linear driver M12 drives the mobile base M14 to move linearly. The linear driver M12 can be a linear actuator.

The convolute motion mechanism M2 includes a rotation driver M22, a first crankshaft 42, a second crankshaft 44, a transmission mechanism M4, and a convolution carrier 70. The electrochemical machining apparatus 1 can further comprises an electrolytic tank 80. The convolute motion mechanism M2 is connected with the linear motion mechanism M1. The rotation driver M22 is disposed on a fixing base M24 and connected to a first end of the first crankshaft 42. The fixing base M24 is disposed on the mobile base M14. The transmission mechanism M4 is disposed at the first end of the first crankshaft 42 and a first end of the second crankshaft 44. The rotation driver M22 can be rotation motor. The convolution carrier 70 is connected to a second end of the first crankshaft 42 and a second end of the second crankshaft 44. One or more conductive columns 10 are disposed on the convolution carrier 70. The electrolyte is located in the electrolytic tank 80 and on the side opposing to the convolution carrier 70.

The electrolytic tank 80 is also disposed on the base B and accommodates electrolyte. The convolute motion mechanism M2 is connected with the linear motion mechanism M1. Thereby, the linear motion mechanism M1 drivers the convolute motion mechanism M2 to move up and down while the convolute motion mechanism M3 performs convolute motion and hence driving the conductive column 10 or the electrode 20. Thereby, the conductive column 10 and the electrode 20 performs relative convolute motion.

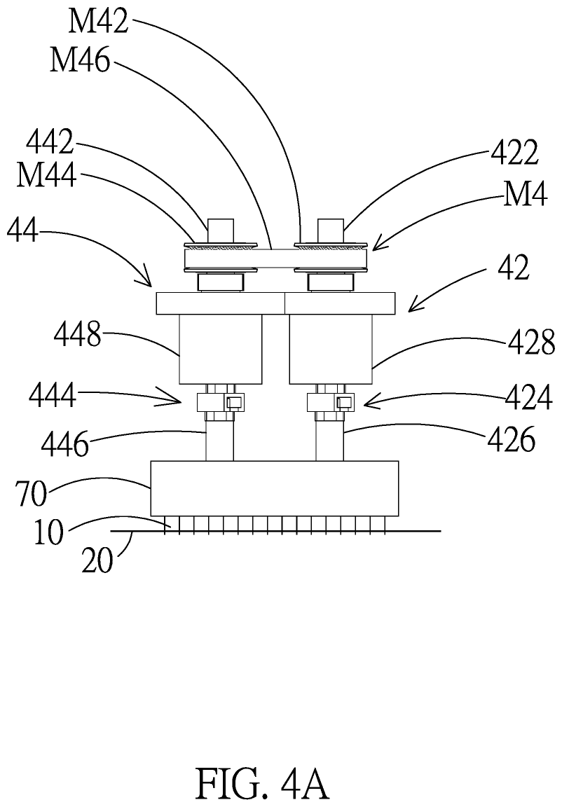

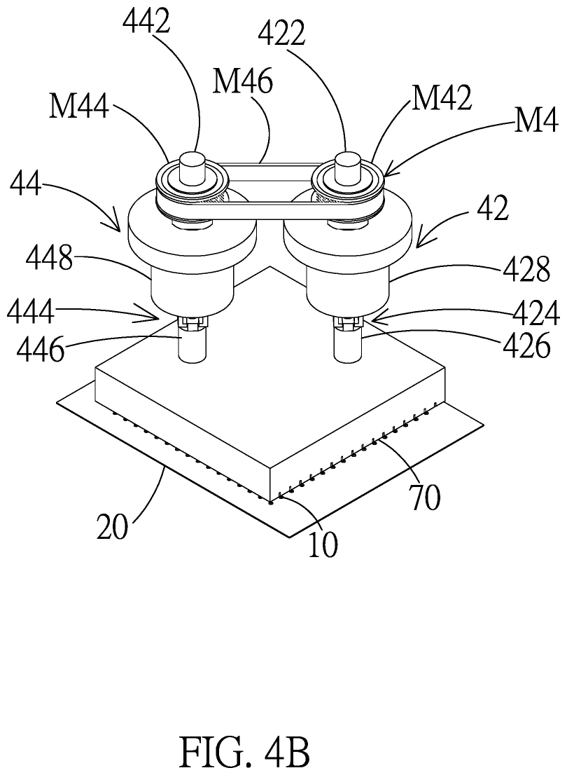

Please refer to FIG. 4A and FIG. 4B. The first crankshaft 42 includes a first shaft 422, a connecting member 424, and a second shaft 426. The second crankshaft 44 includes a first shaft 442, a connecting member 444, and a second shaft 446. A first end of the first shaft 422 of the first crankshaft 42 is connected with the rotation driver M22. The transmission mechanism M4 is disposed at the first end of the first shaft 422 of the first crankshaft 42 and a first end of the first shaft 442 of the second crankshaft 44. The connecting members 424, 444 are connected to a second end of the first shaft 422 and a second end of the first shaft 442, respectively. A first end of the second shaft 426 and a first end of the second shaft 446 are connected to the connecting members 424, 444, respectively. A second end of the second shaft 426 and a second end of the second shaft 446 are connected to the convolution carrier 70. The first shaft 422 of the first crankshaft 42 further passes through an alignment base 428 for connecting to the connecting member 424. The first shaft 442 of the second crankshaft 44 further passes through an alignment base 448 for connecting to the connecting member 444.

The transmission mechanism M4 includes a first transmission wheel M42, a second transmission wheel M44, and a transmission belt M46. The first transmission wheel M42 is disposed at the first end of the first shaft 422 of the first crankshaft 42. The second transmission wheel M44 is disposed at the first end of the first shaft 442 of the second crankshaft 44. The transmission belt M46 is disposed around the first transmission wheel M42 and the second transmission wheel M44. When the rotation driver M22 drives the first crankshaft 42 to rotate, the first crankshaft 42 drives the transmission mechanism M4 and rotating the second crankshaft 44. Thereby, the first crankshaft 42 and the second crankshaft 44 drives the convolution carrier 70 to perform convolute motion (as shown in FIG. 2A). Then the conductive columns 10 on the convolution carrier 70 also perform convolute motion. However, the conductive columns 10 fails to spin.

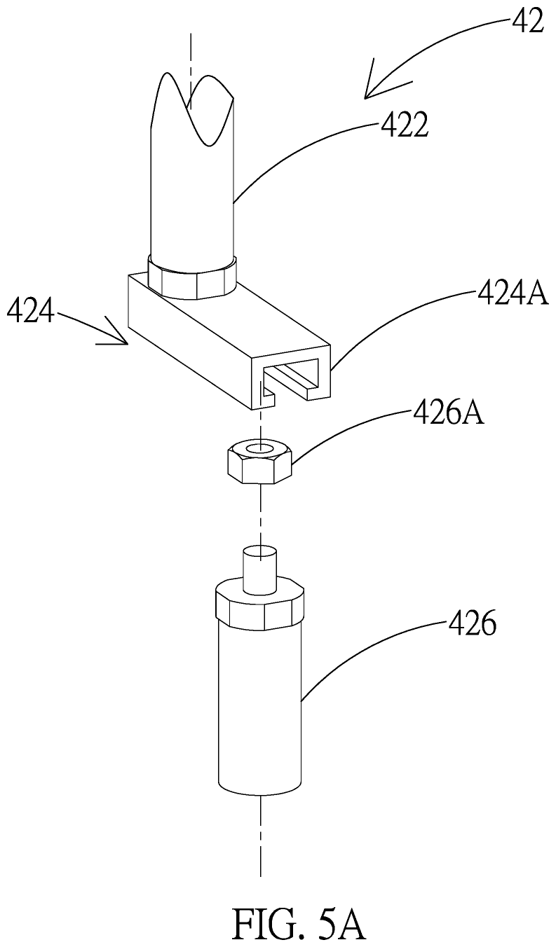

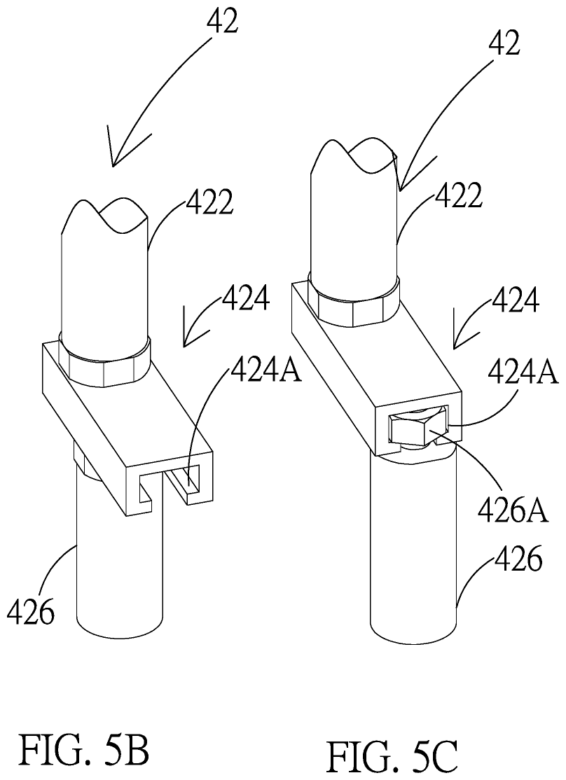

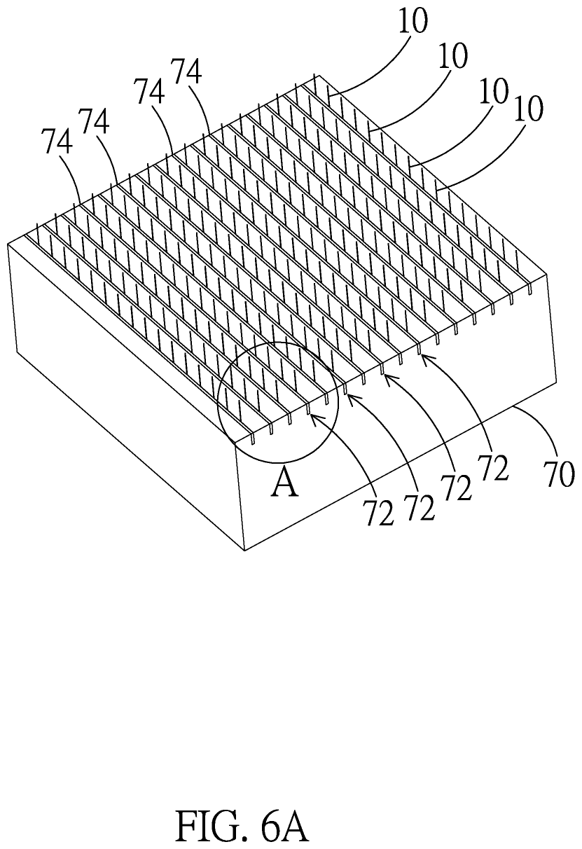

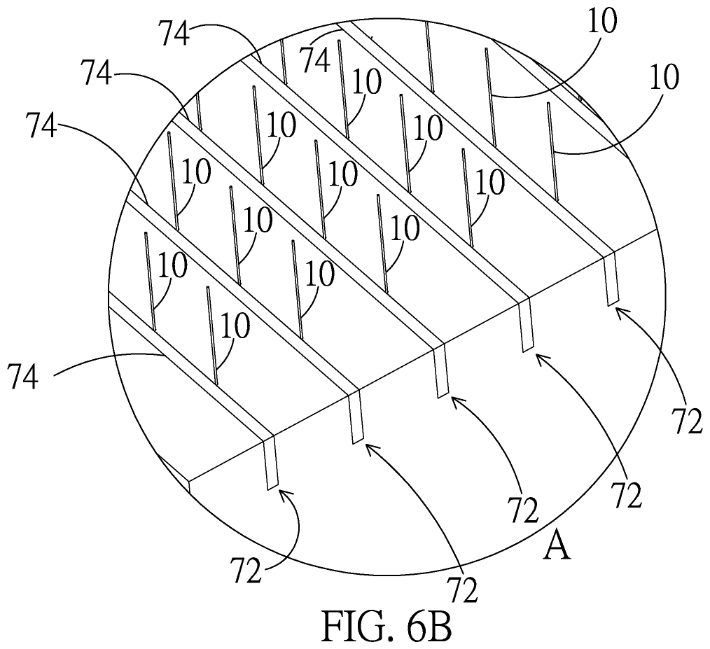

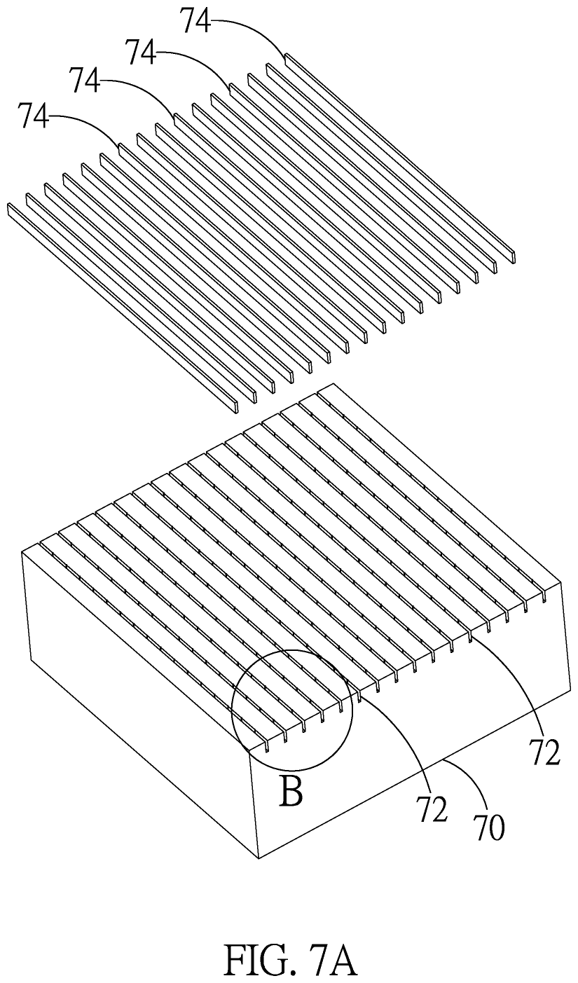

Please refer to FIG. 5A to FIG. 5C, which show an exploded view, a stereoscopic view, and a schematic diagram of adjusting the eccentric distance of the crankshaft of the electromechanical machining apparatus according to an embodiment of the present invention. According to the present embodiment and taking the first crankshaft 42 for example, the second end of the first shaft 422 of the first crankshaft 42 is connected to a first end of the connecting member 424 and the first end of the second shaft 426 of the first crankshaft 42 is connected to the second end of the connecting member 424. Thereby, there is a distance (the eccentric distance between the first shaft 422 and the second shaft 426. In other words, they are not coaxial. The connecting member 424 includes a sliding groove 424A. A sliding member 426A is disposed at the first end of the second shaft 426. The sliding member 426A is accommodated in the sliding groove 424A and slidable along the sliding groove 424A. Thereby, as shown in FIG. 6B and FIG. 6C, the sliding member 426A slides along the sliding groove 424A and thus adjusting the eccentric distance of the first crankshaft 42 for determining the convolution route. Furthermore, the convolution route may be modified for adjusting the size of the hole 22 in the electrode 20.

The electrochemical apparatus 1 is used to execute the method for manufacturing a conebyelectrochemical machining. The rotation driver M22 drives the first crankshaft 42 to motion. The first crankshaft 42 drives the transmission mechanism M4 to drive the second crankshaft 44 to motion. The first and second crankshafts 42, 44 drive the convolution carrier 70 to perform convolute motion and hence driving the conductive columns 10 on the convolution carrier 70 to convolute. Accordingly, the conductive columns 10 perform convolute motion along the convolution route. Meanwhile, the linear motion mechanism M1 moves up and down for driving the conductive columns 10 and the electrode 20 to perform relative approaching and parting motions for performing electrochemical machining and forming cones at the ends 10A.

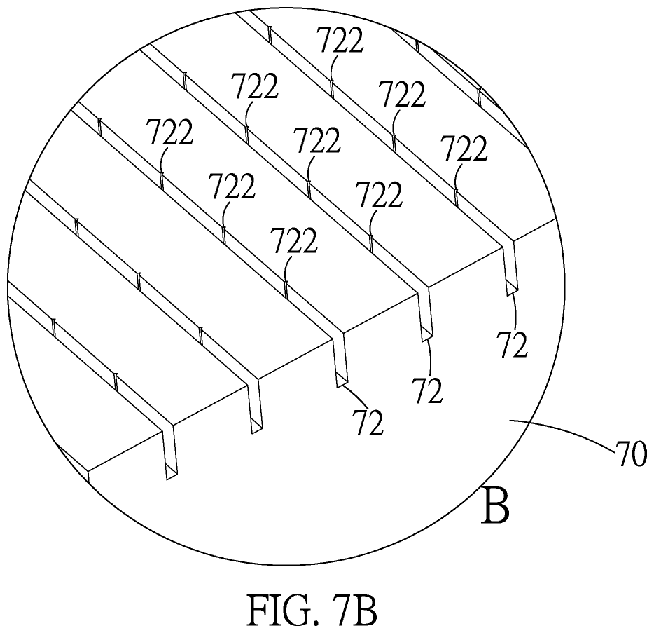

Please refer to FIGS. 6A to 7B. To illustrate the structure of the convolution carrier 70 according to the present invention clearly, the convolution carrier 70 is flipped and illustrated in FIGS. 6A to 7B. As shown in the figures, the convolution carrier 70 includes a plurality of fixing grooves 72. In addition, as shown in FIG. 7A and FIG. 7B, the plurality of fixing grooves 72 include a plurality of alignment grooves 722 on the inner sidewalls, respectively. One end of the plurality of conductive columns 10 is accommodated in the plurality of alignment grooves 722, respectively. The plurality of alignment grooves 722 align the plurality of conductive columns 10. Thereby, as shown in FIG. 6A and FIG. 6B, the plurality of conductive columns 10 are arranged on the convolution carrier 70 and maintain fixed spacing. Alternatively, the plurality of conductive columns can be arranged with unequal spacing. Besides, a plurality of fixing members 74 are accommodated in the plurality of fixing grooves 72, respectively. Thereby, the plurality of conductive columns 10 can be fixed in the plurality of alignment grooves 722.

According to the above embodiment, the plurality of conductive columns 10 are disposed on the convolution carrier 70. Nonetheless, the present invention is not limited to the embodiment. Alternatively, the electrode 20 can be disposed on the convolution carrier 70 and the plurality of conductive columns 10 can be fixed to the electrolytic tank 80. Thereby, the plurality of conductive columns 10 and the electrode 20 can still perform relative convolute motion.

To sum up, the present invention relates to an electrochemical machining method for manufacturing a cone. One or more conductive column and an electrode are driven to perform relative convolute motion. Then the conductive column is driven to perform electrochemical machining on the electrode for forming one or more hole in the electrode. Afterwards, the periphery of the hole in the electrode to perform electrochemical machining on the conductive column for forming a cone at one end of the conductive column.

What is claimed is:

1. A method for manufacturing a cone by electrochemical machining, comprising steps of:
driving one or more conductive column and an electrode to perform relative convolute motion;
driving said conductive column and said electrode to perform relative approaching motion;
driving said conductive column to perform electrochemical machining on said electrode for forming one or more hole in said electrode;
driving said conductive column and said electrode to perform relative parting motion; and
driving the periphery of said hole of said electrode to perform electrochemical machining on said conductive column for forming a cone at one end of said conductive column during said conductive column and said electrode performing said relative parting motion.

2. The electrochemical machining method of claim 1, further comprising a step of adjusting the motion speed of said relative parting motion between said conductive column and said electrode.

3. The electrochemical machining method of claim 2, further comprising a step of reducing the motion speed as the electrochemical machining time of said electrode on said conductive column increases.

4. The electrochemical machining method of claim 1, wheresaid conductive column is further driven to pass through said hole after forming said hole in said electrode.

5. The electrochemical machining method of claim 1, where in said step of driving the periphery of said hole of said electrode to perform electrochemical machining on said conductive column, said conductive column and said electrode are driven to perform relative convolute motion; said conductive column and the periphery of said hole of said electrode perform relative convolute motion.

6. The electrochemical machining method of claim 1, where said conductive column has no spin motion.

7. The electrochemical machining method of claim 1, where in said step of driving said conductive column and said electrode to perform relative convolute motion, said conductive column has no spin.

8. The electrochemical machining method of claim 1, where in said step of driving one or more conductive column and an electrode to perform relative convolute motion, further modifying a convolution route of said relative convolute motion for adjusting a size of said hole in said electrode.

9. The electrochemical machining method of claim 1, where in said step of driving one or more conductive column and an electrode to perform relative convolute motion, said one or more conductive column is driven to perform a convolute motion relative to said electrode.

10. The electrochemical machining method of claim 1, where in said step of driving one or more conductive column and an electrode to perform relative convolute motion, said electrode is driven to perform a convolute motion relative to said one or more conductive column.

11. The electrochemical machining method of claim 1, where in said step of driving said conductive column and said electrode to perform relative approaching motion, said conductive column and said electrode is further driven to perform relative convolute motion.

12. The electrochemical machining method of claim 1, where in said step of driving said conductive column to perform electrochemical machining on said electrode for forming one or more hole in said electrode, said conductive column and said electrode is further driven to perform relative convolute motion.

13. The electrochemical machining method of claim 1, where in said step of driving said conductive column and said electrode to perform relative parting motion, said conductive column and said electrode is further driven to perform relative convolute motion.
